(19) United States
(12) Patent Application Publication
(10) Pub. No.: US 2009/0079716 A1
(43) Pub. Date: Mar. 26, 2009

(54) APPARATUS FOR DRIVING A DISPLAY PANEL, DISPLAY DEVICE HAVING THE APPARATUS FOR DRIVING A DISPLAY PANEL AND INFORMATION PROCESSING APPARATUS HAVING THE DISPLAY DEVICE

(76) Inventors: Jong-Tae Kim, Asan-si (KR); Ki-Hyun Hong, Cheonan-si (KR); Young-Gil Kim, Suwon-si (KR)

Correspondence Address: F. CHAU & ASSOCIATES, LLC, 130 WOODBURY ROAD, WOODBURY, NY, 11797, US

(21) Appl. No.: 12/195,940

(22) Filed: Aug. 21, 2008

(30) Foreign Application Priority Data
Sep. 21, 2007 (KR) 2007-96631

(51) Int. Cl. G09G 5/00; G09G 3/36; H04Q 7/24

(52) U.S. Cl. 345/204; 345/87; 370/338

(57) ABSTRACT

A display device includes a timing controller, a noise removing part, a data driving part and a gate driving part. The timing controller outputs image data and a data clock having a pair of differential signals. The noise removing part is connected to a pair of output terminals for outputting the pair of differential signals. The noise removing part removes common-mode noise included in the pair of differential signals. The data driving part generates an image data signal using the image data and the data clock, and outputs the image data signal to a data line on a display panel. The gate driving part generates a gate signal, and outputs the gate signal to a gate line on the display panel.

### CROSS-REFERENCE TO RELATED APPLICATION

This application claims priority under 35 U.S.C. §119 to Korean Patent Application No. 2007-96631, filed on Sep. 21, 2007 in the Korean Intellectual Property Office (KIPO), the contents of which are herein incorporated by reference in their entirety.

### BACKGROUND OF THE INVENTION

1. Technical Field

The present disclosure relates to an apparatus for driving a display panel, a display device having the apparatus for driving a display panel and an information processing apparatus having the display device. More particularly, the present disclosure relates to an apparatus for driving a display panel with a stable driving signal for an information processing apparatus employing a wireless communication technology, a display device including the apparatus for driving a display panel, and an information processing apparatus including the display device.

2. Discussion of Related Art

Generally, a liquid crystal display (LCD) has display performance and manufacturing costs lower than those of a cathode ray tube (CRT), whereas on the other hand the LCD has some advantages such as slim thickness, light weight, low power consumption, and the like. A thin-film transistor liquid crystal display (TFT-LCD), however, can display an image of high quality and have a display performance substantially the same as that of the CRT. Thus, the TFT-LCD has been employed in various display apparatuses, such as large televisions, notebook computers, mobile terminals, cellular phones, and the like.

Nowadays, as the Internet business environment is evolving, mobile Internet connection systems, such as notebook computers, are being developed. Network communication is evolving from wired communication to wireless communication including wireless regional area networks (WRANs), wireless wide area networks (WWANs), and the like. A user can use a notebook computer employing such wireless communication technology to connect to the Internet anytime and anywhere.

In a wireless communication system, a signal modified by various effects, such as reflections, rotations, multiplications and distortions, and the like, may function as noise that undesirably affects a wireless communication antenna located in the wireless communication system. For example, high-frequency noise generated from a graphic card, a display module, and an interface cable of the notebook computer may function as interference to a wireless communication antenna in the notebook computer when the notebook computer employs the wireless communication technology.

In an information processing apparatus, such as the notebook computer using the wireless communication technology, the noise, such as electrical energy noise or electromagnetic energy noise, generated in the information processing apparatus, has to be minimized in order for the information processing apparatus to transmit and receive data and signals in a stable fashion.

### SUMMARY OF THE INVENTION

Exemplary embodiments of the present invention provide an apparatus for driving a display panel outputting a stable driving signal.

Exemplary embodiments of the present invention provide a display device having the apparatus for driving a display panel.

Exemplary embodiments of the present invention provide an information processing apparatus employing the apparatus for driving a display panel.

In an exemplary embodiment of the present invention, an apparatus for driving a display panel includes a timing controller, a noise removing part, a data driving part and a gate driving part. The timing controller outputs image data and a data clock having a pair of differential signals. The noise removing part is connected to a pair of output terminals that output the differential signals. The noise removing part removes common-mode noise included in the differential signals. The data driving part generates an image data signal using the image data and the data clock, and outputs the image data signal to a data line on the display panel. The gate driving part generates a gate signal, and outputs the gate signal to a gate line on the display panel.

According to an exemplary embodiment of the present invention, an apparatus for driving a display panel includes a timing controller, a common-mode filter, a data driving part and a gate driving part. The timing controller outputs image data and a data clock having a pair of differential signals. The common-mode filter is connected to a pair of output terminals that output the data clock having the differential signals. The common-mode filter removes common-mode noise included in the differential signals. The data driving part generates an image data signal using the image data and the data clock having the pair of differential signals, and outputs the image data signal to a data line on the display panel. The gate driving part generates a gate signal to output a gate line on the display panel.

In an exemplary embodiment of the present invention, a display device includes a display panel, a timing controller, a noise removing part, a data driving part and a gate driving part. The display panel includes a gate line and a data line crossing the gate line, and displays an image. The timing controller outputs image data and a data clock having a pair of differential signals. The noise removing part is connected to a pair of output terminals that output the differential signals. The noise removing part removes common-mode noise included in the differential signals. The data driving part generates an image data signal using the image data and the data clock having the pair of differential signals, and outputs the image data signal to the data line. The gate driving part generates a gate signal, and outputs the gate signal to the gate line.

In an exemplary embodiment of the present invention, an information processing apparatus includes a wireless communication antenna and a display module. The wireless communication antenna receives an information signal in a high-frequency band of a wireless communication technology. The display module includes a display panel and a printed circuit board, and the display panel displays an image. The printed circuit board is disposed on a driving circuit. The printed circuit board includes a timing controller and a noise removing part. The timing controller is electrically connected to the display panel. The timing controller outputs an image data and a data clock having a pair of differential signals. The noise removing part is connected to a pair of output terminals that output the differential signals. The noise removing part can remove the high-frequency noise included in the differential signals.

According to an exemplary embodiment of the present invention, high-frequency noise included in a driving signal of a display panel can be effectively removed, so that the reliability of the information processing apparatus may be enhanced.

### BRIEF DESCRIPTION OF THE DRAWINGS

Exemplary embodiments of the present invention will be understood in more detail from the following descriptions taken in conjunction with the accompanying drawings, in which:

FIG. 1 is a rear plan view illustrating an information processing apparatus in accordance with an exemplary embodiment of the present invention;

FIG. 2 is a block diagram illustrating a display module in accordance with an exemplary embodiment of the present invention;

FIG. 3 is a block diagram illustrating a noise removing part in accordance with an exemplary embodiment of the present invention;

FIG. 4 is a cross-sectional view illustrating the operation of a common-mode filter in accordance with an exemplary embodiment of the present invention;

FIG. 5 is a block diagram illustrating a data driving part in accordance with an exemplary embodiment of the present invention;

FIGS. 6A and 6B are graphs illustrating waveforms of noise diminished by a common-mode filter in accordance with exemplary embodiments of the present invention; and

FIGS. 7A and 7B are graphs illustrating waveforms of noise diminished by a bypass capacitor in accordance with exemplary embodiments of the present invention.

### DETAILED DESCRIPTION OF EXEMPLARY EMBODIMENTS

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those of ordinary skill in the art.

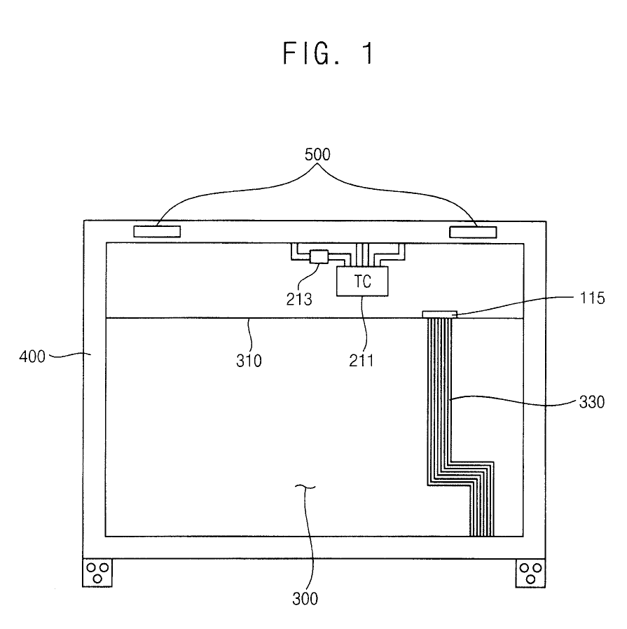

FIG. 1 is a bottom plan view illustrating an information processing apparatus in accordance with embodiments of the present invention.

Referring to FIG. 1, the information processing apparatus includes a display module 300, a receiving member 400 for receiving and supporting the display module 300, and wireless communication antennas 500 for receiving an information signal transferred by a wireless communication technology.

The wireless communication antennas 500 may receive a signal having a frequency band employed in a related wireless communication technology. The wireless communication technology may include a wireless regional area network (WRAN), a wireless wide area network (WWAN) and the like. Table 1 below shows frequency bands and noise levels desired in various Global System for Mobile communications (GSM) and code division multiple access (CDMA) technologies.

TABLE 1

| | | Maximum | |
|---|---|---|---|
| | Frequency | Allowable Noise | |
| Technology | Band (MHz) | (dBm) | Antenna Connected |
| CDMA-850 | 869 to 894 | −101 | ALL WWAN |
| GSM-850 | 869 to 894 | −112 | ALL WWAN |
| GSM-900 | 925 to 960 | −117.5 | ALL WWAN |
| GSM-1800 | 1,805 to 1,880 | −116 | ALL WWAN |
| CDMA-1900 | 1,930 to 1,990 | −105 | ALL WWAN |
| GSM-1900 | 1,930 to 1,990 | −114.5 | ALL WWAN |

The display module 300 includes a source printed circuit board (PCB) 310 and a signal cable 330. The source PCB 310 may be electrically connected to a display panel (not illustrated). The signal cable 330 may electrically connect the source PCB 310 to an external device (not shown).

In an exemplary embodiment, a connector 115 is installed on the source PCB 310 so as to electrically connect the signal cable 330 to a main driving circuit (not shown) for driving the display panel (not shown).

The main driving circuit includes a timing controller (TC) 211 and a noise removing part 213.

The timing controller 211 may receive original data and an original control signal from the external device through the signal cable 330. For example, the external device may transfer the original data and the original control signal into the timing controller 211 by differential signal transfer technology. The differential signal transfer technology may include a low-voltage differential signaling (LVDS) interface technology, a reduced swing differential signaling (RSDS) interface technology, a point-to-point differential signaling (PPDS) interface technology, and the like. In an exemplary embodiment, the external device may transfer the original data and the original control signal into the timing controller 211 by the RSDS interface technology.

The timing controller 211 may generate image data and a data clock for driving the display panel based on the received original data and the original control signal. When the timing controller 211 transfers the image data and the data clock into the display panel by the differential signal transfer technology, the timing controller 211 may generate the image data and the data clock as differential signals.

The timing controller 211 may transfer the image data and the data clock into the display panel by the LVDS interface technology, the RSDS interface technology, the PPDS interface technology, and the like. In an exemplary embodiment, the timing controller 211 may transfer the image data and the data clock into the display panel by the RSDS interface technology. According to the differential signal transfer technology, the image data and the data clock having positive and negative polarities are transferred through a pair of signal lines, respectively.

Although not shown, a data driving part and a gate driving part are electrically connected to the display panel (not shown). The data driving part provides an image data signal to a data line of the display panel and the gate driving part supplies a gate signal to a gate line of the display panel. For example, the data driving part may be electrically connected to the display panel though a tape carrier package and the gate driving part may be provided on the display panel. Alternatively, the data driving part may be disposed on the display panel, and the gate driving part may be electrically connected to the display panel though the tape carrier package. Further, the gate and data driving parts may be disposed on the display panel in chip constructions, respectively.

The noise removing part 213 is electrically connected to a pair of output terminals (not shown) that output the differential signals to remove common-mode noise of a high frequency included in the differential signals. The common-mode noise may include noise levels having substantially the same phases. The common-mode noise may be spread through two signal lines. The common-mode noise is in a high-frequency band of the wireless communication technology received by the wireless communication antennas 500. The noise removing part 213 removes the noise in the the high-frequency band of the wireless communication technology, and the noise is included in the signal outputted from the timing controller 211 disposed adjacent the wireless communication antennas 500. Thus, the noise removing part 213 may prevent the wireless communication antennas 500 from erroneously tuning the noise as a received signal.

The noise removing part 213 may include a common-mode filter removing the common-mode noise. The common-mode filter may be serially connected to a first clock terminal (not shown) outputting a positive data clock and a second clock terminal (not shown) outputting a negative data clock.

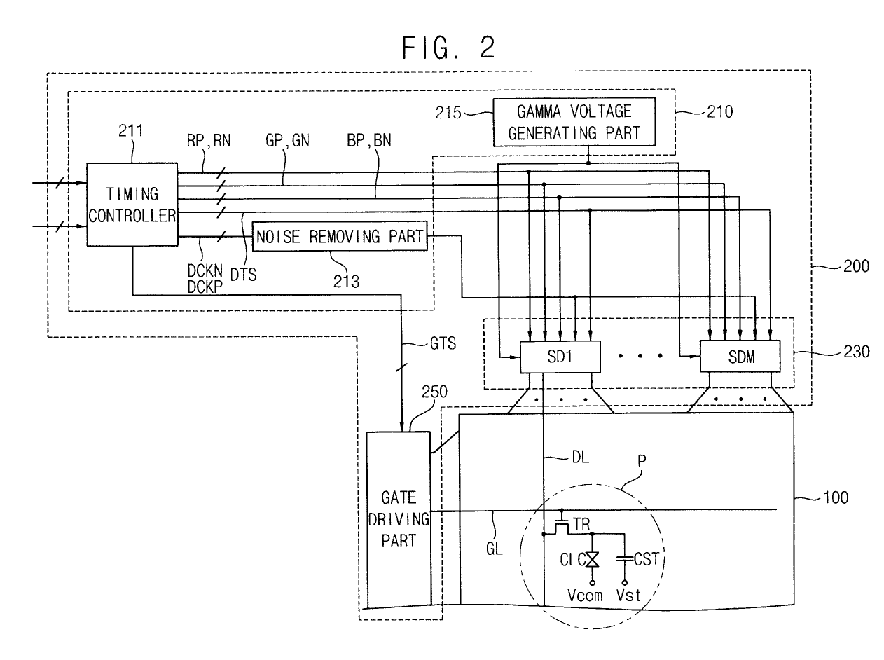

FIG. 2 is a block diagram illustrating a display module in accordance with an exemplary embodiment of the present invention.

Referring to FIG. 2, the display module includes a display panel 100 and a driving device 200 for driving the display panel.

The display panel 100 includes a plurality of data lines DL, a plurality of gate lines GL crossing the data lines DL, and a plurality of pixels, one of which is shown at P shown in the broken line circle, electrically connected to the data lines DL and the gate lines GL. Each of the pixels P includes a switching element TR electrically connected to the data lines DL and the gate lines GL. The switching element TR is further electrically connected to a liquid crystal capacitor CLC and a storage capacitor CST.

The driving device 200 includes a main driving circuit 210, a source driving part 230 and a gate driving part 250.

The main driving circuit 210 includes the timing controller 211, a noise removing part 213 and a gamma voltage generating part 215. The timing controller 211 generates image data RP, RN, GP, GN, BP and, BN and a data clock DCKP and DCKN in the form of a pair of differential signals according to the differential signal transfer technology using original data and an original control signal received from an external device (not shown). Additionally, the timing controller 211 generates a data timing signal DTS for controlling the data driving part 230 and a gate timing signal GTS for controlling the gate driving part 250 based on the original control signal.

The noise removing part 213 includes the common-mode noise filter. The common-mode noise filter is serially connected to a pair of output terminals that outputs the pair of differential signals among output terminals of the timing controller 211. The noise removing part 213 may remove noise in a high-frequency band of the wireless communication technology from the differential signals. For example, the common-mode noise filter may be electrically connected to a first clock terminal and a second clock terminal outputting a pair of data clock signals DCKN and DCKP.

The gamma voltage generating part 215 generates a plurality of gamma voltages and provides the gamma voltages to the data driving part 230. For example, the gamma voltage generating part 215 may include a resistor string circuit that includes a plurality of resistors serially connected to one another. The resistor string circuit may divide a source voltage and a ground voltage into the plurality of gamma voltages, and then may output the gamma voltages to the data driving part 230.

The data driving part 230 generates a single signal using the image data RP, RN, GP, GN, and BP, BN in the form of the pairs of differential signals, and the data driving part 230 converts the single signal into an analog image data voltage using the gamma voltages. Then, the data driving part 230 outputs the image data voltage to the data line. The data driving part 230 operates based on the data timing signal DTS generated from the timing controller 211. The data driving part 230 includes a plurality of driving chips SD1, . . . , SDM. Each of the diving chips SD1, . . . , SDM may output the image data voltage to a plurality of grouped data lines.

The gate driving part 250 generates the gate signal, and then the gate driving part 250 outputs the gate signal to the gate line GL. The gate driving part 250 sequentially outputs the gate signal to the gate line GL based on the gate timing signal GTS generated by the timing controller 211.

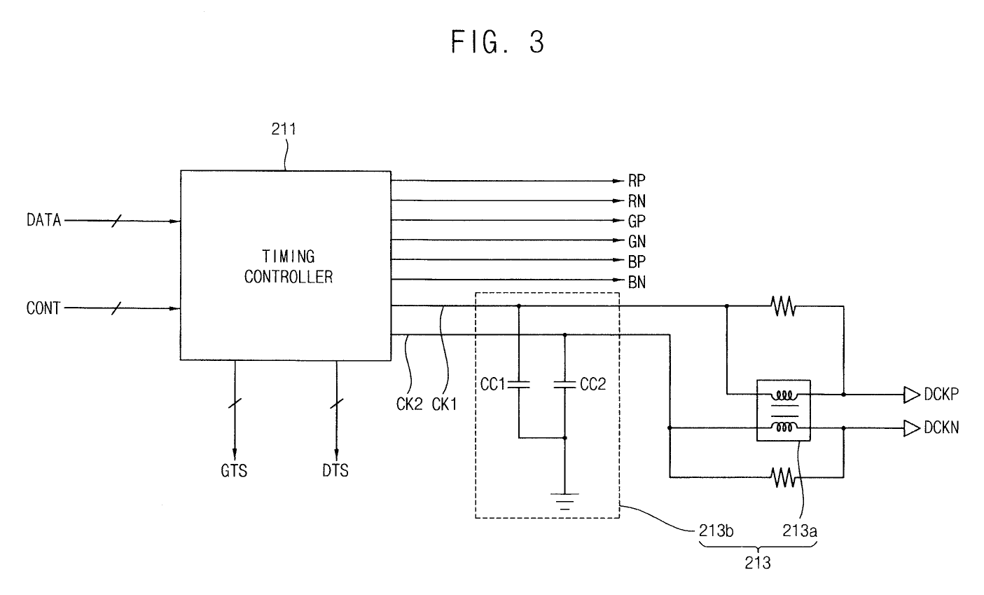

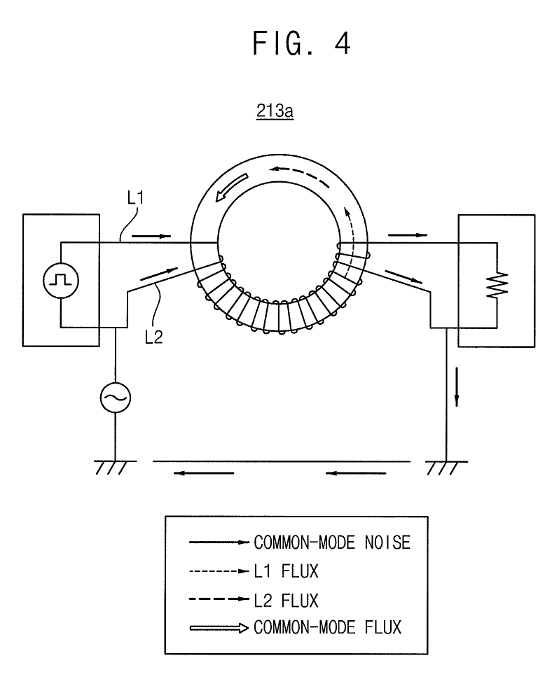

FIG. 3 is a block diagram illustrating the noise removing part 213 in more detail in accordance with an exemplary embodiment of the present invention, and FIG. 4 is a schematic illustrating the operation of a common-mode noise filter in accordance with an exemplary embodiment of the present invention.

Referring to FIGS. 2 and 3, the timing controller 211 receives the original data DATA and the original control signal CONT by the LVDS technology that belongs to the differential signal transfer technology. The timing controller 211 converts the original data DATA into the image data RP, RN, GP, GN, BP and, BN and the data clock DCKP and DCKP in the form of the pair of differential signals by the RSDS technology that belongs to the differential signal transfer technology. For example, the timing controller 211 may output a plurality of differential signals including positive red data RP, negative red data RN, positive green data GP, negative green data GN, positive blue data BP, negative blue data BN, a positive data clock DCKP, and a negative data clock DCKN.

The noise removing part 213 is electrically connected to a first clock signal line CK1 and a second clock signal line CK2 of the timing controller 211 for use in outputting the positive data clock DCKP and the negative data clock DCKN, respectively. For example, the noise removing part 213 may include a common-mode noise filter 213a and a bypass part 213b.

The common-mode noise filter 213a separates noise from the differential signals in a high-frequency band to cut off the noise. Thus, the common-mode noise filter 213a passes the differential signals without the noise.

Referring to FIG. 4, the common-mode filter noise 213a includes a first coil L1 and a second coil L2 disposed in parallel to the first coil L1. When the pair of differential signals are applied to the first and the second coils L1 and L2, a common-mode magnetic flux is formed in the first and the second coils L1 and L2. The common-mode magnetic flux removes common-mode noise included in the differential signals so as to pass the differential signals without the common-mode noise. Therefore, the common-mode noise filter 213a may output the differential signals without the common-mode noise.

In an exemplary embodiment, the common-mode noise filter 213a removes the common-mode noise included in the positive data clock DCKP and the negative data clock DCKN, and then the common-mode noise filter 213a outputs the positive data clock DCKP and the negative data clock DCKN without the common-mode noise.

The bypass part 213b shown in FIG. 3 includes a first bypass capacitor CC1 connected to the first clock signal line CK1 and connected in parallel a second bypass capacitor CC2 connected to the second clock signal line CK2. The bypass part 213b removes ripple noise remaining in the positive data clock DCKP and the negative data clock DCKN from which the common-mode noise is removed by the common-mode noise filter 213a. That is, the first and the second bypass capacitors CC1 and CC2 are electrically connected to ground, so as to bypass to ground the ripple noise included in the positive data clock DCKP and the negative data clock DCKN.

In an exemplary embodiment, the noise removing part 213 removes the common-mode noise included in the positive and the negative data clocks DCKP and DCKN by the common-mode noise filter 213a, and additionally removes the ripple noise remaining in the positive and the negative data clocks DCKP and DCKN by the bypass part 213b.

In an exemplary embodiment, the noise removing part 213 may remove the ripple noise from the positive and the negative data clocks DCKP and DCKN using the bypass part 213b, and may additionally remove the common-mode noise remaining in the positive and the negative data clocks DCKP and DCKN using the common-mode filter 213a.

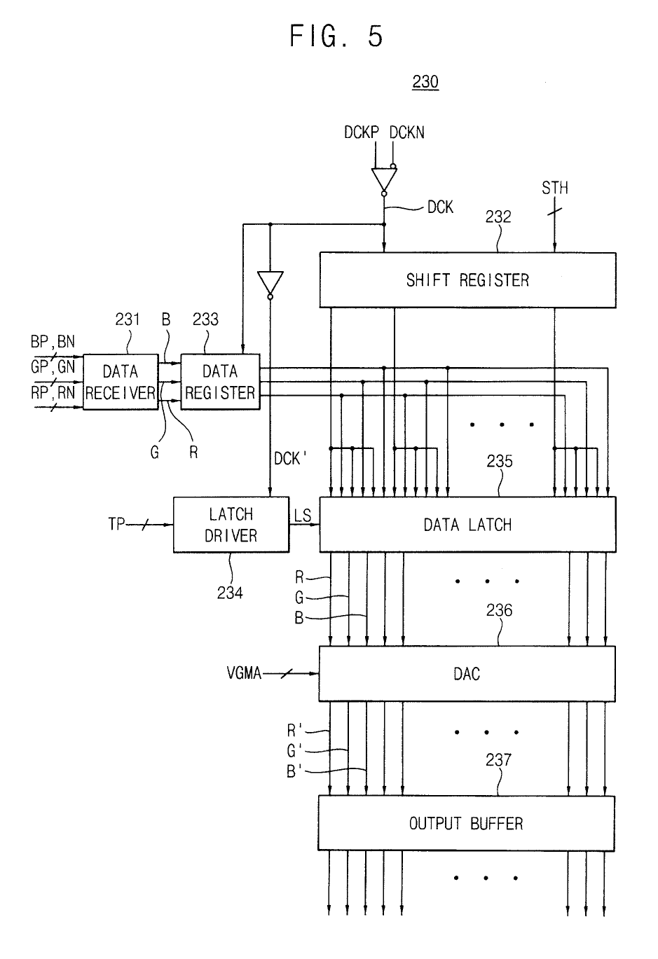

FIG. 5 is a block diagram illustrating a data driving part in accordance with an exemplary embodiment of the present invention.

Referring to FIGS. 2 and 5, the data driving part 230 includes a data receiver 231, a shift register 232, a data register 233, a latch driver 234, a data latch 235, a digital-to-analog converter (DAC) 236, and an output buffer 237.

The data receiver 231 receives red, green and blue data RP, RN, GP, GN, BP, and BN in the form of pairs of differential signals. The data receiver 231 converts the red, the green and the blue data RP, RN, GP, GN, BP, and BN into red, green and blue data R, G, and B each having a single signal.

The shift register 232 receives a horizontal starting signal STH and a data clock signal DCK converted from the data clocks DCKP and DCKN in the form of the pair of differential signals by a differential amplifier. The shift register 232 shifts the horizontal starting signal STH in response to the data clock signal DCK and generates a sampling signal. Then, the shift register 232 outputs the sampling signals to the data latch 235.

The data register 233 outputs the red, the green, and the blue data R, G, and B to the data latch 235 in response to the data clock signal DCK.

The latch driver 234 outputs a latch signal LS to the data latch 235 in response to a load signal TP applied from the timing controller 211 shown in FIG. 2, and a data clock signal DCK′ having a phase opposite to that of the data clock signal DCK.

The data latch 235 includes a plurality of unit latches, which sample the data R, G, and B in response to a sampling signal, and then the data latch 235 sequentially latches the data R, G, and B into the unit latches. The data latch 235 outputs the latched data R, G, and B to the DAC 236.

The DAC 236 converts the data R, G, and B into image data voltages R′, G′, and B′ of analog type using the gamma voltages, and then the DAC 236 outputs the image data voltages R′, G′, and B′ to the output buffer 237.

The output buffer 237 includes a plurality of unit buffers that buffer the image data voltages R′, G′, and B′ so as to output to the data lines DL shown in FIG. 2.

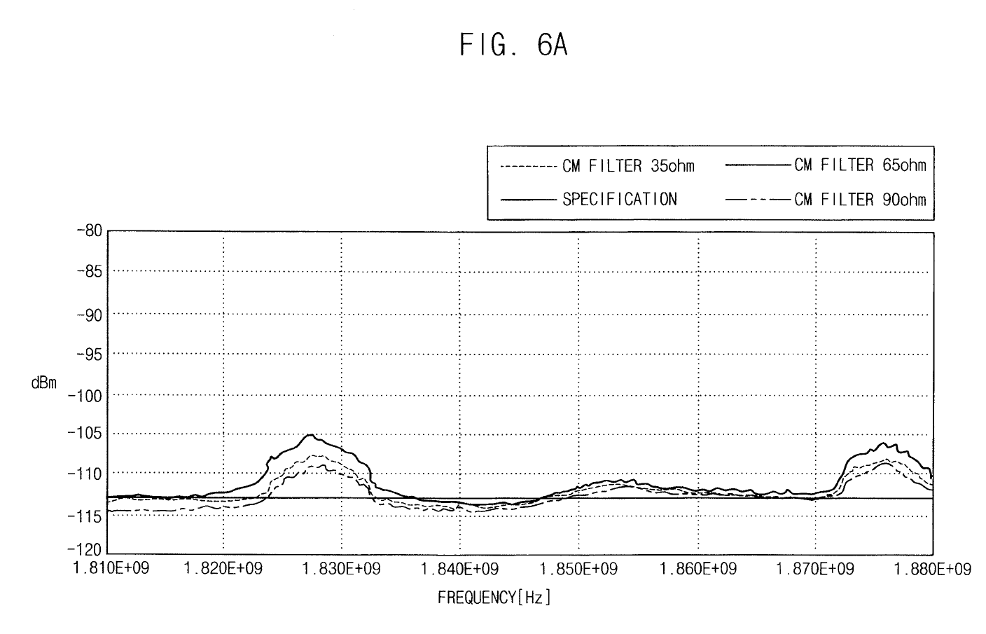

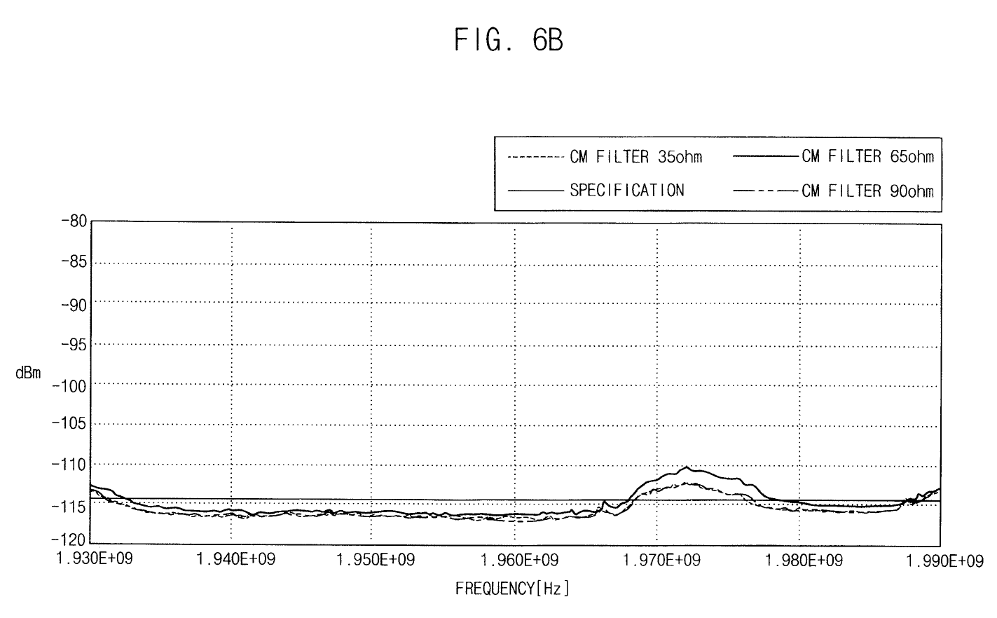

FIGS. 6A and 6B are graphs illustrating waveforms of noise diminished by a common-mode filter in accordance with exemplary embodiments of the present invention.

FIG. 6A is a graph illustrating waveforms tuned by a wireless communication antenna in a notebook computer employing GSM- 1800 technology in accordance with various resistances of common-mode filters. In this exemplary embodiment, the notebook computer includes bypass capacitors CC1 and CC2 shown in FIG. 2, each having capacitances of about 0.008 nF.

Referring to FIG. 6A, the waveform at which the resistance is 90Ω among the waveforms at which the resistances of common-mode filters are about 35Ω, about 65Ω and 90Ω, respectively, reaches an allowable noise level of about −116 dBm according to the specification of the GSM-1800 technology. The level of the waveform corresponding to the resistance of about 90Ω is reduced by about 2 dBm to about 3 dBm in comparison with the level of the waveform corresponding to the resistance of about 35Ω.

FIG. 6B is a graph illustrating waveforms tuned by a wireless communication antenna in a notebook computer employing the GSM-1900 technology in accordance with various resistances of common-mode filters. In this exemplary embodiment, the notebook computer includes bypass capacitors CC1 and CC2 shown in FIG. 2, each having capacitances of about 0.008 nF.

Referring to FIG. 6B, the waveform at which the resistance is 90Ω among the waveforms at which the resistances of common-mode filters are about 35Ω, about 65Ω and about 90Ω, respectively, reaches an allowable noise level of about −114.5 dBm according to the specification of the GSM-1900 technology. The level of the waveform corresponding to the resistance of about 90Ω is smaller by about 2 dBm to about 3 dBm in comparison with the level of the waveform corresponding to the resistance of about 35Ω.

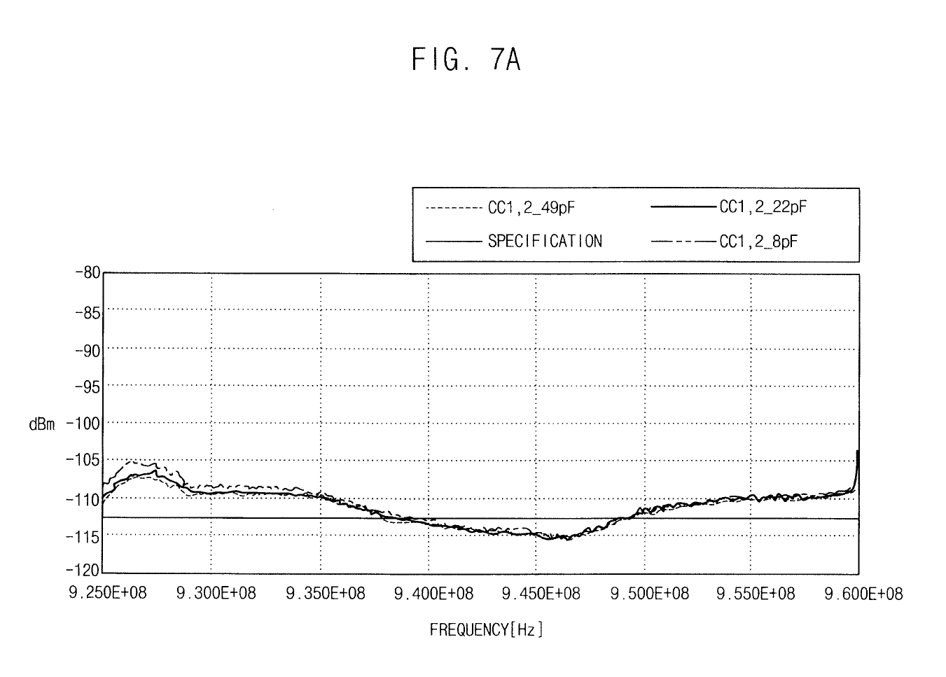

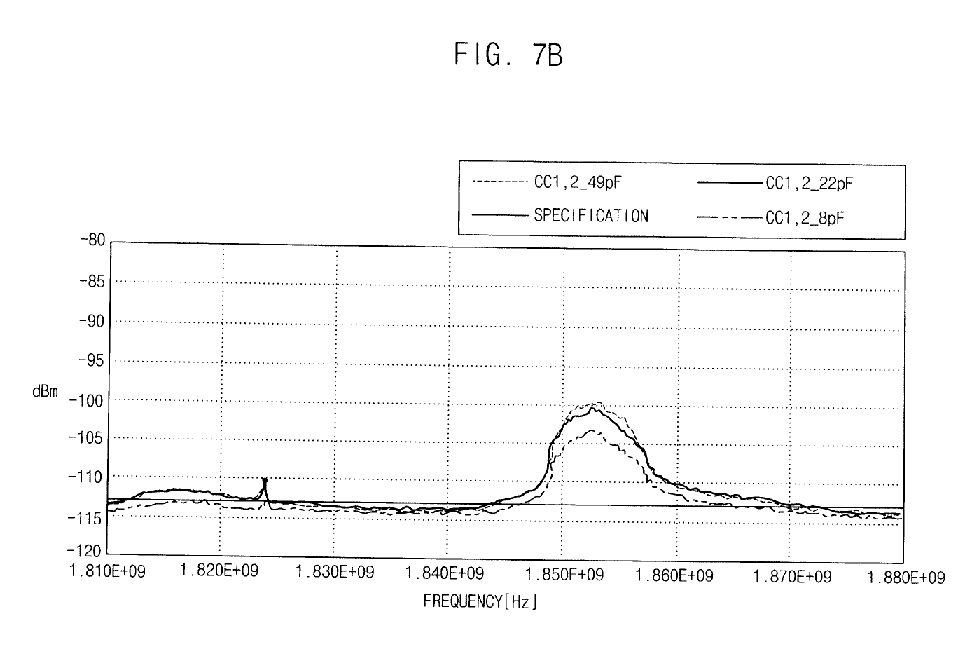

FIGS. 7A and 7B are graphs illustrating waveforms of noise diminished by a bypass capacitor in accordance with exemplary embodiments of the present invention.

FIG. 7A is a graph illustrating waveforms tuned by a wireless communication antenna in a notebook computer employing the GSM-900 technology in accordance with various capacitances of bypass capacitors. In this exemplary embodiment, the notebook computer includes a common-mode filter having a resistance of about 90Ω.

Referring to FIG. 7A, the waveform at which the capacitance is about 0.8 pF among the waveforms at which the capacitances of the bypass capacitors CC1, CC2 are about 0.49 pF, about 0.22 pF and 0.8 pF, respectively, reaches an allowable noise level of about −117.5 dBm according to the specification of the GSM-900 technology. The level of the waveform corresponding to the capacitance of about 0.8 pF is smaller by about 2 dBm to about 3 dBm in comparison with the waveform corresponding to the capacitance of about 0.49 pF.

FIG. 7B is graph illustrating waveforms tuned by a wireless communication antenna in a notebook computer employing the GSM-1800 technology in accordance with various capacitances of the bypass capacitors. In this exemplary embodiment, the notebook computer includes the common-mode filter having a resistance of about 90Ω.

Referring to FIG. 7B, the waveform at which the capacitance is about 0.8 pF among the waveforms at which the capacitances of the bypass capacitors CC1, CC2 are about 0.49 pF, about 0.22 pF and about 0.8 pF, respectively, reaches an allowable noise of about −116 dBm according to the specification of the GSM-1800 technology. The level of the waveform corresponding to the capacitance of about 0.8 pF is smaller by about 2 dBm to about 3 dBm in comparison with the level of the waveform corresponding to the capacitance of about 0.49 pF.

As set forth above, FIGS. 6A and 7B are graphs illustrating the waveforms tuned by the wireless communication antenna in the notebook computer employing the GSM-1800 technology.

As illustrated in FIGS. 6A and 7B, the common-mode noise filter and the bypass capacitors remove noise in the high-frequency bands that are different from each other. Referring to FIG. 6A, the common-mode filters may effectively remove the noise in the high-frequency band of about 1.830E+9 and about 1.880E+9. Referring to FIG. 7B, the bypass capacitors may effectively remove the noise in the high-frequency band of about 1.85E+9.

Therefore, the common-mode filter and the bypass capacitors may efficiently remove the noise of high-frequency bands that are different from each other.

According to exemplary embodiments of the present invention, a common-mode noise filter connected to output terminals that output differential signals may effectively remove noise of a high frequency included in the differential signals. Additionally, bypass capacitors connected to the output terminals may bypass ripple noise of the high frequency to ground so as to effectively remove the ripple noise. Here, the term ripple noise indicates noise included in the differential signals from which the noise is removed by the common-mode noise filter.

According to exemplary embodiments of the present invention, noise of a high frequency included in a driving signal of a display panel may be removed, thereby preventing the noise from being received by the wireless communication antenna. As a result, the reception of an information processing apparatus employing the wireless communication technology may be improved.

The foregoing is illustrative of the present invention and is not to be construed as limiting thereof. Although exemplary embodiments of the present invention have been described, those of ordinary skill in the art will readily appreciate that many modifications are possible in the exemplary embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the exemplary embodiments disclosed, and that modifications to the disclosed embodiments, as well as other exemplary embodiments, are intended to be included within the scope of the appended claims. The present invention is defined by the following claims, with equivalents of the claims to be included therein.

What is claimed is:

1. An apparatus for driving a display panel, comprising:
a timing controller outputting image data and a data clock in the form of a pair of differential signals;
a noise removing part connected to a pair of output terminals that output the pair of differential signals, the noise removing part removing common-mode noise included in the pair of differential signals;
a data driving part generating an image data signal using the image data and the data clock, and outputting the image data signal to a data line on the display panel; and
a gate driving part generating a gate signal, and outputting the gate signal to a gate line on the display panel.

2. The device of claim 1, wherein the noise removing part includes a common-mode noise filter serially connected to the output terminals, wherein the common-mode noise filter removes common-mode noise included in the pair of differential signals.

3. The device of claim 2, wherein the noise removing part further includes a plurality of bypass capacitors connected to the output terminals in parallel wherein the bypass capacitors bypass noise included in the pair of differential signals to ground.

4. The device of claim 3, wherein the noise has a frequency in a frequency band of a wireless wide area network (WWAN).

5. The device of claim 1, wherein the noise removing part is connected to a pair of clock terminals that output the data clock having the pair of differential signals.

6. The device of claim 1, wherein the timing controller generates the pair of differential signals by a reduced swing differential signaling (RSDS) interface technology.

7. An apparatus for driving a display panel, comprising:
a timing controller outputting image data and a data clock in the form of a pair of differential signals, respectively;
a common-mode noise filter connected to a pair of output terminals that output the data clock having the pair of differential signals, the common-mode noise filter removing common-mode noise included the pair of differential signals;
a data driving part generating an image data signal using the image data and the data clock having the pair of differential signals, and outputting the image data signal to a data line on the display panel; and
a gate driving part generating a gate signal to output a gate line on the display panel.

8. The device of claim 7, further comprising a plurality of bypass capacitors connected in parallel to the pair of output terminals that output the data clock having the pair of differential signals, wherein the bypass capacitors bypass noise included in the pair of differential signals to ground.

9. A display device comprising:
a display panel including a gate line and a data line crossing the gate line for displaying an image;
a timing controller outputting image data and a data clock in the form of a pair of differential signals, respectively;
a noise removing part connected to a pair of output terminals that output the pair of differential signals, the noise removing part removing common-mode noise included in the pair of differential signals;
a data driving part generating an image data signal using the image data and the data clock having the pair of differential signals, and outputting the image data signal to the data line; and
a gate driving part generating a gate signal, and outputting the gate signal to the gate line.

10. The display device of claim 9, wherein the noise removing part includes a common-mode noise filter serially connected to the pair of output terminals wherein the common-mode filter removes common-mode noise included in the pair of differential signals.

11. The display device of claim 10, wherein the noise removing part further includes a plurality of bypass capacitors connected in parallel to the pair of output terminals, wherein the bypass capacitors bypass noise included in the pair of differential signals to ground.

12. The display device of claim 11, wherein the noise has a frequency in a frequency band of a wireless wide area network (WWAN).

13. The display device of claim 9, wherein the noise removing part is connected to a pair of clock terminals that output the data clock having the pair of differential signals.

14. The display device of claim 9, wherein the timing controller generates the differential signals by an RSDS interface technology.

15. An information processing apparatus comprising:
a wireless communication antenna receiving an information signal in a high-frequency band of a wireless communication transmission; and
a display module comprising:
a display panel displaying an image; and
a printed circuit board disposed on a driving circuit including:
a timing controller electrically connected to the display panel, and outputting image data and a data clock in the form of a pair of differential signals; and
a noise removing part connected to a pair of output terminals that output the pair of differential signals, and removing noise having the high frequency included in the differential signals.

16. The information processing apparatus of claim 15, wherein the noise removing part includes a common-mode noise filter serially connected to the pair of output terminals, wherein the common-mode noise filter removes common-mode noise included in the pair of differential signals.

17. The information processing apparatus of claim 16, wherein the noise removing part further includes a plurality of bypass capacitors connected in parallel to the pair of output terminals, wherein the bypass capacitors bypass noise included in the pair of differential signals to ground.

18. The information processing apparatus of claim 17, wherein the noise has the high frequency in a frequency band of a wireless wide area network (WWAN).

19. The information processing apparatus of claim 15, wherein the noise removing part is connected to a pair of clock terminals that output the data clock having the pair of differential signals.
